(19) United States
(12) Patent Application Publication
(10) Pub. No.: US 2025/0252936 A1
(43) Pub. Date: Aug. 7, 2025

(54) DISPLAY DRIVER INTEGRATED CIRCUIT AND ELECTRONIC DEVICE

(71) Applicant: HUAWEI TECHNOLOGIES CO., LTD., Shenzhen (CN)

(72) Inventor: Yancan MIN, Chengdu (CN)

(21) Appl. No.: 19/188,094

(22) Filed: Apr. 24, 2025

Related U.S. Application Data
(63) Continuation of application No. PCT/CN2023/099687, filed on Jun. 12, 2023.

(30) Foreign Application Priority Data
Oct. 25, 2022 (CN) 202211312649.8

(51) Int. Cl. G09G 5/39; G09G 3/20

(52) U.S. Cl. CPC G09G 5/39; G09G 3/20

(57) ABSTRACT

A display driver integrated circuit and an electronic device are disclosed, and relate to the field of display technologies, to resolve a problem of poor array depth adaptation of a graphic random access memory. The display driver integrated circuit includes the graphic random access memory, where the graphic random access memory includes a plurality of memory arrays, an array depth of the memory array is not equal to 2ⁿ, and n is a positive integer, and an address mapper, coupled to an address port of the graphic random access memory, and configured to map addresses of the plurality of memory arrays, to make the addresses of the plurality of memory arrays to be contiguous.

### CROSS-REFERENCE TO RELATED APPLICATION

This application is a continuation of International Application No. PCT/CN2023/099687, filed on Jun. 12, 2023, which claims priority to Chinese Patent Application No. 202211312649.8, filed on Oct. 25, 2022. The disclosures of the aforementioned applications are hereby incorporated by reference in their entireties.

### TECHNICAL FIELD

This application relates to the field of display technologies, and in particular, to a display driver integrated circuit and an electronic device.

### BACKGROUND

With development of display technologies, electronic devices with display functions become indispensable electronic tools in people's daily life.

A graphic random access memory (GRAM) is usually integrated into a display driver integrated circuit inside the electronic device. The GRAM is configured to store image data and image algorithm data of the electronic device. However, an array depth of a current GRAM can only be 2ⁿ. Consequently, array depth adaptation of the GRAM is limited and cannot meet different requirements.

### SUMMARY

Embodiments of this application provide a display driver integrated circuit and an electronic device, to resolve a problem of poor array depth adaptation of a graphic random access memory.

To achieve the foregoing objective, this application uses the following technical solutions.

According to a first aspect of embodiments of this application, a display driver integrated circuit (DDIC) is provided. The display driver integrated circuit may be used in an electronic device. The display driver integrated circuit includes: a graphic random access memory (GRAM), where the graphic random access memory includes a plurality of memory arrays (e.g., banks) and a buffer (buffer), the buffer is coupled to the memory array, an array depth (depth) of the memory array is not equal to 2ⁿ, and n is a positive integer; and an address mapper, coupled to an address port of the graphic random access memory, and configured to map addresses of the plurality of memory arrays, to make the addresses of the plurality of memory arrays to be contiguous.

When the array depth of the memory array in the graphic random access memory is not 2ⁿ, the addresses of the plurality of memory arrays may be discontiguous. However, the address mapper is added and the discontiguous addresses of the plurality of memory arrays are mapped into contiguous addresses, so that a problem of address holes between the plurality of memory arrays can be resolved. Therefore, in the display driver integrated circuit provided in this embodiment of this application, an array depth of the graphic random access memory may be any depth, and is not limited by 2ⁿ while ensuring that the addresses of the plurality of memory arrays are contiguous. This resolves a problem that the array depth of the graphic random access memory meets 2ⁿ, to meet different requirements. In addition, the address mapper can be implemented by simple combination logic. The address mapper is easy to implement, occupies a small area, and is easy to integrate in the display driver integrated circuit.

In a possible implementation, capacities of at least two memory arrays of the plurality of memory arrays are unequal. In the graphic random access memory in this embodiment of this application, the array depth of each memory array is not limited by 2ⁿ. Therefore, a capacity of the memory array is not limited by 2ⁿ either, and the capacity of each memory array may be flexibly set according to a requirement of the display driver integrated circuit, to reduce a quantity of memory arrays in the graphic random access memory, reduce an area of the graphic random access memory, and reduce costs.

In a possible implementation, an array width of the memory array is not equal to 2ⁿ bits. In the display driver integrated circuit in this embodiment of this application, the address mapper may map the discontiguous addresses of the plurality of memory arrays into the contiguous addresses. Therefore, in the display driver integrated circuit provided in this embodiment of this application, an array width of the graphic random access memory may be any array width, and is not limited by 2ⁿ bits while ensuring that the addresses of the plurality of memory arrays are contiguous. This resolves a problem that the array width of the graphic random access memory needs to be 2ⁿ bits, to meet different requirements.

In a possible implementation, the array depth of the memory array is 6400. The array depth can be directly limited to a required array depth, to simplify a structure.

In a possible implementation, the array width of the memory array is 96 bits or 192 bits. The array width can be directly limited to a required array width, to simplify a structure.

In a possible implementation, the address mapper is located outside the graphic random access memory. In this way, a size of the graphic random access memory can be optimized.

In a possible implementation, the graphic random access memory further includes a plurality of buffers. The plurality of buffers are correspondingly coupled to the plurality of memory arrays. The buffer is configured to pre-buffer an output signal of a memory array coupled to the buffer, to improve a driving capability of the memory array.

In a possible implementation, the graphic random access memory further includes a controller. The controller is coupled to the plurality of buffers.

In a possible implementation, the display driver integrated circuit includes a plurality of graphic random access memories. Capacities of at least two graphic random access memories of the plurality of graphic random access memories are unequal. Embodiments of this application provide a graphic random access memory with an array width and an array depth that can be randomly customized. Therefore, capacities of a plurality of graphic random access memories included in a display driver integrated circuit may be any required capacities, to meet different requirements.

In a possible implementation, the graphic random access memory is in a strip shape, and the plurality of memory arrays are arranged in a length direction of the image memory. This is a possible implementation.

According to a second aspect of embodiments of this application, an electronic device is provided. The electronic device includes a circuit board and a display driver integrated circuit. The display driver integrated circuit is coupled to the circuit board. The display driver integrated circuit is the display driver integrated circuit according to any one of the possible implementations of the first aspect.

The electronic device provided in this embodiment of this application includes the display driver integrated circuit according to the first aspect. Beneficial effect of the electronic device is the same as beneficial effect of the display driver integrated circuit.

### BRIEF DESCRIPTION OF DRAWINGS

FIG. 1A is a diagram of a framework of an electronic device according to an example embodiment of this application;

FIG. 1B is an internal layout diagram of an electronic device according to an example embodiment of this application;

FIG. 2A is a diagram of a structure of a graphic random access memory according to an example embodiment of this application;

FIG. 2B is a diagram of a structure of another graphic random access memory according to an example embodiment of this application;

FIG. 3 is a diagram of a structure of a graphic random access memory according to an example embodiment of this application;

FIG. 4 is a diagram of internal arrangement of a memory array according to an example embodiment of this application;

FIG. 5 is a diagram of an address mapping process according to an example embodiment of this application;

FIG. 6 is an internal layout diagram of another electronic device according to an example embodiment of this application; and

FIG. 7 is an internal layout diagram of still another electronic device according to an example embodiment of this application.

### DESCRIPTION OF EMBODIMENTS

The following describes the technical solutions in embodiments of this application with reference to the accompanying drawings in embodiments of this application. It is clear that the described embodiments are merely a part rather than all of embodiments of this application.

The terms such as “first” and “second” below are only for ease of description, and cannot be understood as indicating or implying relative importance or implicitly indicating a quantity of indicated technical features. Therefore, a feature limited by “first”, “second”, or the like may explicitly or implicitly include one or more features. In the descriptions of this application, unless otherwise stated, “a plurality of” means two or more than two.

In addition, in embodiments of this application, orientation terms such as “upper”, “lower”, “left”, and “right” may include but are not limited to definitions based on illustrated orientations in which components in the accompanying drawings are placed. It should be understood that, these direction terms may be relative concepts. The orientation terms are used for relative description and clarification, and may vary accordingly depending on a change in the orientations in which the components in the accompanying drawings are placed in the accompanying drawings.

In embodiments of this application, unless otherwise clearly specified and limited, the term “connection” should be understood in a broad sense. For example, the “connection” may indicate a fixed connection, a detachable connection, or an integral connection; or may indicate direct interconnection, or indirect interconnection through an intermediate medium. In addition, the term “coupling” may indicate a direct electrical connection, or may indicate an indirect electrical connection through an intermediate medium. The term “contact” may indicate direct contact or indirect contact through an intermediate medium.

In embodiments of this application, the term “and/or” describes an association relationship between associated objects and may indicate that at least three relationships exist. For example, A and/or B may indicate the following cases: Only A exists, both A and B exist, and only B exists, where A and B may be singular or plural. The character “/” generally indicates an “or” relationship between the associated objects.

Embodiments of this application provide an electronic device. The electronic device is, for example, a consumer electronic product, a home electronic product, a vehicle-mounted electronic product, or a financial terminal product. The consumer electronic product is, for example, a mobile phone, a tablet computer, a notebook computer, an e-reader, a personal computer (PC), a personal digital assistant (PDA), a desktop display, an intelligent wearable product (for example, a smart watch or a smart band), a virtual reality (VR) terminal device, an augmented reality (AR) terminal device, or an uncrewed aerial vehicle. The home electronic product is, for example, a smart door lock, a television, a remote control, a refrigerator, or a small household rechargeable appliance (for example, a soy milk maker or a robot vacuum cleaner). The vehicle-mounted electronic product is, for example, a vehicle-mounted navigator or a vehicle-mounted high-density digital video disc (DVD). The financial terminal product is, for example, an automated teller machine (ATM), or a terminal for self-service business handling.

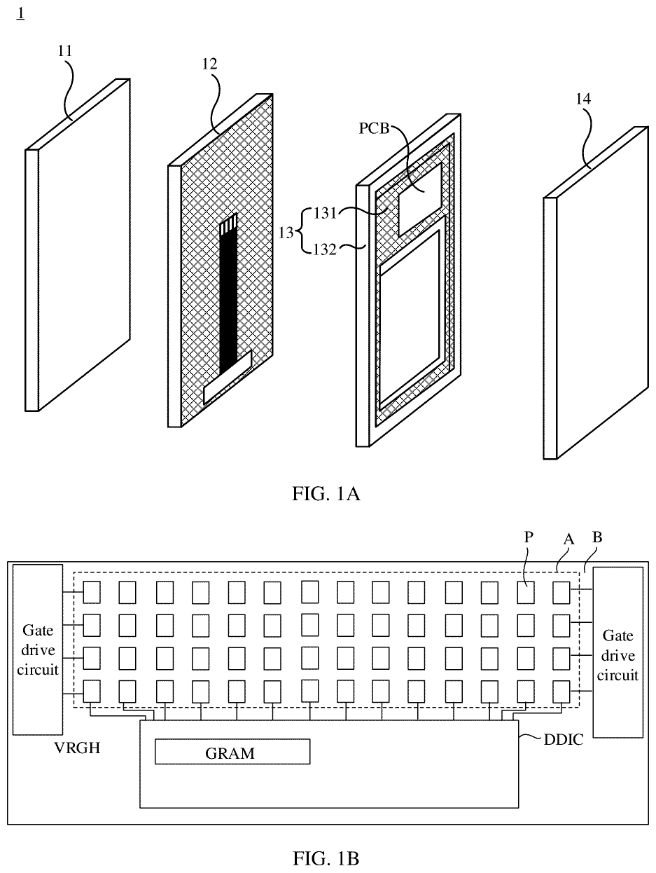

For ease of description, the following uses an example in which the electronic device is a mobile phone for description. As shown in FIG. 1A, an electronic device 1 mainly includes a cover plate 11, a display panel 12, a middle frame 13, and a rear housing 14. The rear housing 14 and the display panel 12 are respectively located on two sides of the middle frame 13, the middle frame 13 and the display panel 12 are disposed in the rear housing 14, the cover plate 11 is disposed on a side that is of the display panel 12 and that is away from the middle frame 13, and a display surface of the display panel 12 faces the cover plate 11.

The display panel 12 may be a liquid crystal display (LCD). In this case, the liquid crystal display panel includes a liquid crystal display panel and a backlight module. The liquid crystal display panel is disposed between the cover plate 11 and the backlight module, and the backlight module is configured to provide a light source for the liquid crystal display panel. The display panel 12 may alternatively be an organic light-emitting diode (OLED) display panel. Because the OLED display panel is a self-luminous display panel, no backlight module needs to be disposed.

The middle frame 13 includes a bearing plate 131 and a side frame 132 surrounding the bearing plate 131. The electronic device 1 may further include electronic components such as a printed circuit board (PCB), a battery, and a camera. The electronic components such as the printed circuit board, the battery, and the camera may be disposed on the bearing plate 131.

As shown in FIG. 1B, the display panel 12 includes an active area (AA) A and a peripheral area B located around the active area A.

In some embodiments, the active area A of the display panel 12 is used as a display area of the electronic device 1, and the peripheral area B of the display panel 12 is used as a non-display area of the electronic device 1.

As shown in FIG. 1B, the active area A of the display panel 12 includes a plurality of sub-pixels P. For ease of description, in this application, descriptions are provided by using an example in which the plurality of sub-pixels P are arranged in a form of matrix. In this case, sub-pixels P arranged in a line in a horizontal direction are referred to as sub-pixels in a same row, and sub-pixels P arranged in a line in a vertical direction are referred to as sub-pixels in a same column.

The electronic device 1 includes a gate drive circuit and a source drive circuit that are located in the peripheral area B of the display panel 12. The gate drive circuit is configured to provide a gate drive signal for the sub-pixel P, and the source drive circuit is configured to provide a source drive signal for the sub-pixel P.

In some embodiments, an example in which the display panel 12 is an OLED display panel is used. The display panel 12 includes a display. The display includes a substrate and an OLED element disposed on the substrate. The OLED element is configured to independently emit light under driving of the gate drive circuit and the source drive circuit.

For example, the gate drive circuit may be integrated on the substrate by using, for example, a gate on array (GOA) technology. The gate drive circuit includes a plurality of cascaded shift registers (SRs).

There may be one or more gate drive circuits. For example, as shown in FIG. 1B, the electronic device 1 includes two gate drive circuits, and the two gate drive circuits are disposed on two sides of the active area A in the horizontal direction. For ease of illustration, an example in which the electronic device 1 includes one gate drive circuit is used below for illustration.

For example, the source drive circuit may be integrated into a display driver integrated circuit (DDIC). For example, the display driver integrated circuit DDIC is a die (die), and the display driver integrated circuit DDIC is directly attached to the substrate.

For example, the display driver integrated circuit DDIC is coupled to the PCB of the electronic device 1 through a flexible circuit board (FPC).

In some embodiments, as shown in FIG. 1B, the display driver integrated circuit includes a graphic random access memory (GRAM). The graphic random access memory GRAM is configured to store image data and image algorithm data of the electronic device.

For example, the graphic random access memory GRAM is a large-capacity static random access memory (SRAM).

For example, a capacity of the graphic random access memory GRAM is approximately 40 Mbit to 60 Mbit, and an area of the graphic random access memory GRAM accounts for 20% to 30% of an area of the entire display driver integrated circuit DDIC.

Because the display driver integrated circuit DDIC is attached to the substrate in a form of die, to reduce costs, a display manufacturing factory requires that a pin of a display driver integrated circuit DDIC manufactured by a display driver integrated circuit DDIC manufacturing factory be compatible with a pin of a display. This indirectly requires that shapes and sizes of display driver integrated circuits DDICs manufactured by the display driver integrated circuit DDIC manufacturing factory be basically the same.

Because the display driver integrated circuit DDIC needs to provide a data signal for each column of sub-pixels P in the display, more data signal (e.g., source) output channels are required. For example, the display driver integrated circuit DDIC needs 2560 output channels. Therefore, the display driver integrated circuit DDIC is usually designed as a thin strip. For example, the display driver integrated circuit DDIC is rectangular in shape, 33 mm long and 1.5 mm wide.

To match the shape of the display driver integrated circuit DDIC, a shape of the graphic random access memory GRAM usually needs to be designed as a slender shape.

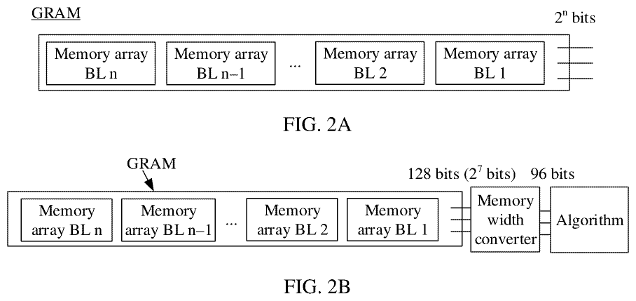

Because the graphic random access memory GRAM has a large capacity and needs to be designed to be in a slender shape, in some technologies, as shown in FIG. 2A, the graphic random access memory GRAM includes a plurality of memory arrays (e.g., banks). The plurality of memory arrays are: a memory array BL 1, a memory array BL 2, . . . , a memory array BL n−1, and a memory array BL n.

Array depths of the memory arrays BLs are equal, a capacity of each memory array BL is 2ⁿ, and n is a positive integer. In this way, after the plurality of memory arrays BLs are spliced, a large-capacity graphic random access memory GRAM with contiguous addresses may be formed.

If the capacity of the memory array BL is not 2ⁿ, addresses of the plurality of memory arrays BLs are discontiguous, and a hole occurs.

However, because the capacity of each memory array BL needs to be aligned with 2ⁿ, an array depth of the graphic random access memory GRAM needs to be 2ⁿ, and an array width of the graphic random access memory GRAM also needs to be 2ⁿ bits. This directly affects design flexibility of the graphic random access memory GRAM. For example, a display automatic visual detection and defect correction (e.g., demura) algorithm expects the array width of the graphic random access memory GRAM to be 96 bits, but there is no appropriate value for n in 2ⁿ bits to make 2ⁿ equal to 96. Therefore, the foregoing solution cannot meet a requirement, and adaptability is poor.

In addition, an optional range of the capacity of each memory array BL is limited. A capacity doubles after each threshold-crossing. This easily causes a capacity waste.

Further, in each technology, a shape and an area of a minimum bit cell used by the graphic random access memory GRAM are fixed, and finally, optional space for a shape and a size of each memory array BL in each graphic random access memory GRAM is limited. As a result, costs are affected.

To resolve a problem of poor adaptability of the graphic random access memory GRAM, in some technologies, as shown in FIG. 2B, the graphic random access memory GRAM is coupled to an array width converter.

A function of the array width converter is to change the array width of the graphic random access memory GRAM, so that the array width of the graphic random access memory GRAM is converted into an array width required by an algorithm.

For example, an original requirement of the demura algorithm is an SRAM with a capacity of about 13.8 Mbit and an array width of 96 bits. Based on the technical solution shown in FIG. 2B, the graphic random access memory GRAM may be designed as a single SRAM with a capacity of 13.8 Mbit and an array width of 128 bits. Alternatively, the graphic random access memory GRAM may be designed as two SRAMs with a capacity of 6.9 Mbit and an array width of 64 bits. Alternatively, the graphic random access memory GRAM may be designed as two SRAMs with a capacity of 6.9 Mbit and an array width of 128 bits.

If a single graphic random access memory GRAM with a capacity of 13.8 Mbit and an array width of 96 bits is designed, based on a limitation of a layout of the entire display driver integrated circuit DDIC, an optional solution is as follows: There are 27 memory arrays BLs in total, an array width of each memory array BL is 128 bits, and a capacity of each memory array BL is 512 Kbit (2⁹ Kbit). In this way, a total capacity of a finally formed graphic random access memory GRAM may reach 27*512=13.824 Mbit. Then, the array width is converted from 128 bits to 96 bits by using the array width converter.

Although the foregoing solution can meet an array width requirement of the algorithm and also meet a total capacity requirement of the graphic random access memory GRAM, a large quantity of memory arrays BLs are required, resulting in a large total area of the graphic random access memory GRAM and an array width waste.

Based on this, to implement a small total area of the graphic random access memory GRAM and meet different array width requirements, embodiments of this application provide a new display driver integrated circuit.

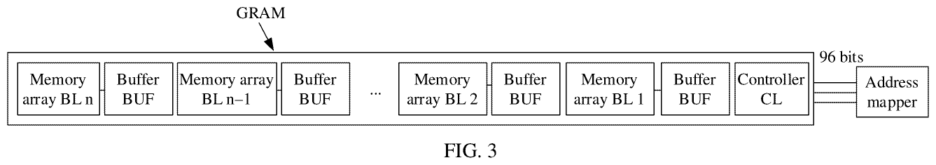

As shown in FIG. 3, the display driver integrated circuit DDIC includes a graphic random access memory GRAM and an address mapper.

The graphic random access memory GRAM includes a plurality of memory arrays BLs. In FIG. 3, an example in which the plurality of memory arrays BLs are: a memory array BL 1, a memory array BL 2, . . . , a memory array BL n−1, and a memory array BL n is used for illustration.

Certainly, on a basis of including the memory array BL, the graphic random access memory GRAM may further include a decoder, a driver, a timing controller, a buffer, and the like. Alternatively, it is understood that the memory array BL is a component that can implement storage, and the graphic random access memory GRAM further includes a circuit component, to control writing data into the memory array BL or reading data in the memory array BL.

For example, as shown in FIG. 3, the graphic random access memory GRAM is in a strip shape, and the plurality of memory arrays BLs are arranged in a length direction of the graphic random access memory GRAM.

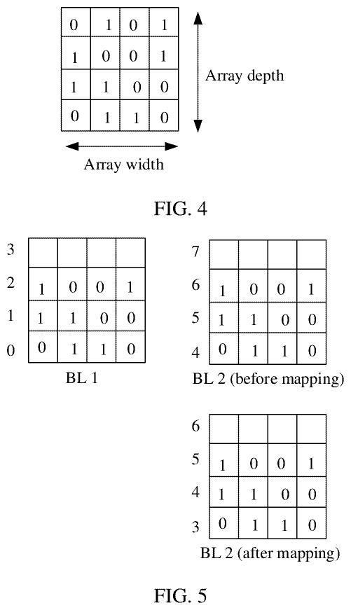

As shown in FIG. 4, the memory array BL includes a row and a column, a quantity of rows of the memory array BL is an array depth, and the row is specified by an address. A quantity of columns of the memory array BL is an array width, and a read or written value is data. A size of the memory array BL is equal to the array depth multiplied by the array width. FIG. 4 is shown by using an example in which the memory array BL is 2ⁿ*2ⁿ.

In some embodiments, the array depth of the memory array BL included in the graphic random access memory GRAM in this embodiment of this application is not equal to 2ⁿ, and n is a positive integer. In other words, the array depth of the memory array BL is not limited by 2ⁿ, and may be directly an actually required array depth.

In some embodiments, the array width of the memory array BL included in the graphic random access memory GRAM in this embodiment of this application is not equal to 2ⁿ bits. In other words, the array width of the memory array BL is not limited by 2ⁿ bits, and may be directly an actually required array width.

In some embodiments, as shown in FIG. 3, the graphic random access memory GRAM further includes a plurality of buffers (BUFs). The plurality of buffers BUFs are correspondingly coupled to the plurality of memory arrays BLs, and each memory array BL is correspondingly coupled to the buffer BUF. The buffer BUF is configured to pre-buffer an output signal of a memory array BL coupled to the buffer BUF, to improve a driving capability of the memory array BL.

A structure of the buffer BUF is not limited in this embodiment of this application, and a buffer BUF used in the graphic random access memory GRAM in a conventional technology is applicable to this application.

For example, as shown in FIG. 3, the plurality of memory arrays BLs and the plurality of buffers BUFs are alternately arranged in the length direction of the graphic random access memory GRAM.

In some embodiments, as shown in FIG. 3, the graphic random access memory GRAM further includes a controller (ctrl). The controller CL is coupled to the plurality of buffers BUFs. The controller CL is configured to control read and write of the memory array BL.

For example, the controller CL is disposed at an end that is of the graphic random access memory GRAM and that is close to an input/output port.

The address mapper is coupled to an address port of the graphic random access memory GRAM, and is configured to map addresses of the plurality of memory arrays BLs, to make the addresses of the plurality of memory arrays BLs to be contiguous.

For example, as shown in FIG. 5, the array width of the memory array BL is 4 bits, and addresses of the memory array BL are 22. For example, addresses of the memory array BL 1 are 0, 1, 2, and 3, and addresses of the memory array BL 2 are 4, 5, 6, and 7. When the graphic random access memory GRAM accesses the addresses 0, 1, and 2 of the memory array BL 1, the graphic random access memory GRAM can perform access. When the graphic random access memory GRAM accesses the address 3 of the memory array BL 1, the address 3 is empty and cannot be accessed. The address mapper maps the addresses of the memory array BL 2, and maps the addresses of the memory array BL 2 from original 4, 5, 6, and 7 to 3, 4, 5, and 6. When the graphic random access memory GRAM accesses the address 3, the address 3 of the memory array BL 2starts to be accessed. In this way, addresses of the graphic random access memory GRAM are contiguous on the whole.

For example, a single graphic random access memory GRAM with a capacity of 13.8 Mbit and an array width of 96 bits is designed. Based on a limitation of a layout of the entire display driver integrated circuit DDIC, an optional solution is as follows: There are 23 memory arrays BLs in total, an array width of each memory array BL is 96 bits, an array depth of the memory array BL is not limited by 2ⁿ, and a depth of the memory array BL is 6400. A capacity of each memory array BL is (6400*96 bits)/1024=600 Kbit. In this way, a total capacity of a finally formed graphic random access memory GRAM may reach 23*600=13.8 Mbit. An array width of the graphic random access memory GRAM is directly 96 bits. The address mapper is used to solve a problem of address holes between the memory arrays BLs. In comparison with the conventional technology in which the array width is 128 bits, in this embodiment of this application, a quantity of memory arrays BLs in the graphic random access memory GRAM may be reduced by 4.

Therefore, when the array depth of the memory array BL in the graphic random access memory GRAM is not 2ⁿ, the addresses of the plurality of memory arrays BLs may be discontiguous. However, the address mapper is added and the discontiguous addresses of the plurality of memory arrays BLs are mapped into contiguous addresses, so that a problem of address holes between the plurality of memory arrays BLs can be resolved. Therefore, in the display driver integrated circuit DDIC provided in this embodiment of this application, an array depth and an array width of the graphic random access memory GRAM may be any array depth and any array width, and are not limited by 2ⁿ while ensuring that the addresses of the plurality of memory arrays BLs are contiguous. This resolves a problem that the array depth and the array width of the graphic random access memory GRAM need to meet 2ⁿ, to meet different requirements. In addition, the address mapper can be implemented by simple combination logic. The address mapper is easy to implement, occupies a small area, and is easy to integrate in the display driver integrated circuit DDIC.

In this embodiment of this application, the array depth and the array width of the memory array BL are not limited by 2ⁿ. Therefore, the capacity of the memory array BL may be flexibly customized according to a requirement.

In some embodiments, capacities of the plurality of memory arrays BLs are equal.

In this way, an implementation of the memory array BL can be simplified.

In some other embodiments, capacities of at least two memory arrays BLs of the plurality of memory arrays BLs are unequal.

For example, capacities of the memory arrays BLs are all unequal.

Alternatively, for example, in the plurality of memory arrays BLs, capacities of some memory arrays BLs are equal, and capacities of some memory arrays BLs are unequal.

In the graphic random access memory GRAM in this embodiment of this application, the capacity of each memory array BL is not limited by 2ⁿ, and the capacity of each memory array BL may be flexibly set according to a requirement of the display driver integrated circuit DDIC, to reduce the quantity of memory arrays BLs in the graphic random access memory GRAM, reduce an area of the graphic random access memory GRAM, and reduce costs.

In this embodiment of this application, the array width of the memory array BL is not limited by 2ⁿ bits. Therefore, the capacity of the memory array BL may be flexibly customized according to a requirement. In this case, a size of the memory array BL is flexibly set based on the capacity of the memory array BL, and the size of the memory array BL is no longer limited by 2ⁿ.

Because the memory array BL includes a plurality of bit cells, capacities of memory arrays BLs are different, and quantities of bit cells required by the memory arrays BLs are different, three-dimensional shapes of the memory arrays BLs are also different. Therefore, the size of the memory array BL may be understood as a size of a three-dimensional edge of the memory array BL.

In some embodiments, sizes of the plurality of memory arrays BLs are equal.

For example, the capacities of the plurality of memory arrays BLs are equal, and the sizes of the plurality of memory arrays BLs are also equal.

In some other embodiments, sizes of at least two memory arrays BLs of the plurality of memory arrays BLs are unequal.

For example, sizes of the memory arrays BLs are all unequal.

Alternatively, for example, in the plurality of memory arrays BLs, sizes of some memory arrays BLs are equal, and sizes of some memory arrays BLs are unequal.

If a size of one of a plurality of three-dimensional edges of the memory arrays BLs is different, sizes of the memory arrays BLs in this embodiment of this application are unequal.

In the graphic random access memory GRAM in this embodiment of this application, the size of each memory array BL is not limited by 2ⁿ, and a quantity of bit cells included in each memory array BL may be flexibly set according to a requirement of the display driver integrated circuit DDIC, thereby reducing costs.

In some embodiments, as shown in FIG. 3, the address mapper is located outside the graphic random access memory GRAM.

In this way, a size of the graphic random access memory GRAM can be optimized.

In some other embodiments, the address mapper is integrated inside the graphic random access memory GRAM.

In this way, a connection manner between the graphic random access memory GRAM and the address mapper may be simplified.

In some embodiments, the array width of the memory array BL is 96 bits.

In some other embodiments, the array width of the memory array BL is 192 bits.

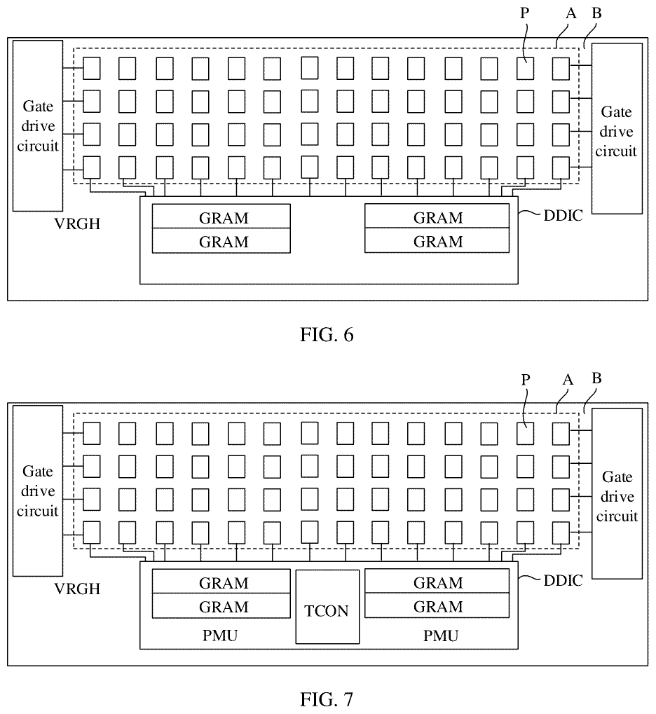

In some embodiments, as shown in FIG. 6, the display driver integrated circuit DDIC includes a plurality of graphic random access memories GRAMs.

For example, capacities of the plurality of graphic random access memories GRAMs are equal.

Alternatively, for example, capacities of at least two graphic random access memories GRAMs of the plurality of graphic random access memories GRAMs are unequal.

For example, capacities of the plurality of graphic random access memories GRAMs are all unequal.

Alternatively, for example, in the plurality of graphic random access memories GRAMs, capacities of some graphic random access memories GRAMs are equal, and capacities of some graphic random access memories GRAMs are unequal.

In this embodiment of this application, an array width and a capacity of the graphic random access memory GRAM may be randomly customized. Therefore, when the display driver integrated circuit DDIC includes the plurality of graphic random access memories GRAMs, the capacities of the plurality of graphic random access memories GRAMs may be randomly customized.

In some embodiments, none of array widths of the plurality of graphic random access memories GRAMs are equal to 2ⁿ bits.

In some other embodiments, in the plurality of graphic random access memories GRAMs, array widths of some graphic random access memories GRAMs are not equal to 2ⁿ bits, and array widths of some graphic random access memories GRAMs are equal to 2ⁿ bits.

For example, the array widths of the plurality of graphic random access memories GRAMs are equal, and none of the array widths of the plurality of graphic random access memories GRAMs are equal to 2ⁿ bits.

Alternatively, for example, array widths of at least two graphic random access memories GRAMs of the plurality of graphic random access memories GRAMs are unequal.

For example, array widths of at least two graphic random access memories GRAMs of the plurality of graphic random access memories GRAMs are unequal, and neither of the array widths of the at least two graphic random access memories GRAMs are equal to 2ⁿ bits.

Alternatively, for example, array widths of at least two graphic random access memories GRAMs of the plurality of graphic random access memories GRAMs are unequal, and in the at least two graphic random access memories GRAMs, array widths of some graphic random access memories GRAMs are not equal to 2ⁿ bits, and array widths of some graphic random access memories GRAMs are equal to 2ⁿ bits.

Embodiments of this application provide a graphic random access memory GRAM with an array width that can be randomly customized. Therefore, array widths of a plurality of graphic random access memories GRAMs included in a display driver integrated circuit DDIC may be equal to 2ⁿ bits, or may not be equal to 2ⁿ bits, to meet different requirements.

In some embodiments, as shown in FIG. 7, the display driver integrated circuit DDIC further includes a power management unit (PMU). The power management unit PMU is configured to perform conversion processing (for example, voltage boosting and voltage bucking) on a received power signal.

In some embodiments, as shown in FIG. 7, the display driver integrated circuit DDIC further includes a timing controller TCON. The timing controller TCON is configured to provide a timing signal for the electronic device.

The foregoing descriptions are merely specific implementations of this application, but are not intended to limit the protection scope of this application. Any variation or replacement within the technical scope disclosed in this application shall fall within the protection scope of this application. Therefore, the protection scope of this application shall be subject to the protection scope of the claims.

1. A display driver integrated circuit, comprising:
a graphic random access memory having a plurality of memory arrays and a buffer, wherein the buffer is coupled to the memory array, an array depth of the memory array is not equal to 2ⁿ, and n is a positive integer; and
an address mapper, coupled to an address port of the graphic random access memory, wherein the address mapper is configured to map addresses of the plurality of memory; to make the addresses of the plurality of memory arrays to be contiguous.

2. The display driver integrated circuit according to claim 1, wherein capacities of at least two memory arrays, of the plurality of memory arrays, are not equal.

3. The display driver integrated circuit according to claim 1, wherein the memory array includes an array width not equal to 2ⁿ bits.

4. The display driver integrated circuit according to claim 1, wherein the array depth of the memory array is 6400.

5. The display driver integrated circuit according to claim 1, wherein the memory array include an array width of 96 bits or 192 bits.

6. The display driver integrated circuit according to claim 1, wherein the address mapper is located outside the graphic random access memory.

7. The display driver integrated circuit according to claim 1, wherein the graphic random access memory further comprises a plurality of buffers correspondingly coupled to the plurality of memory arrays.

8. The display driver integrated circuit according to claim 7, wherein the graphic random access memory further comprises a controller coupled to the plurality of buffers.

9. The display driver integrated circuit according to claim 1, wherein the display driver integrated circuit comprises a plurality of graphic random access memories, and capacities of at least two graphic random access memories, of the plurality of graphic random access memories, are not equal.

10. An electronic device, comprising:
a circuit board; and
a display driver integrated circuit, wherein
the display driver integrated circuit comprises:
a graphic random access memory having a plurality of memory arrays and a buffer, wherein the buffer is coupled to the memory array, an array depth of the memory array is not equal to 2ⁿ, and n is a positive integer; and
an address mapper coupled to an address port of the graphic random access memory, wherein the address mapper is configured to map addresses of the plurality of memory arrays to make the addresses of the plurality of memory arrays to be contiguous.
